(19) United States
(12) Patent Application Publication
(10) Pub. No.: US 2024/0241758 A1
(43) Pub. Date: Jul. 18, 2024

(54) FLEXIBLE COMPUTING RESOURCE CLUSTER ALLOCATION

(71) Applicant: Target Brands, Inc., Minneapolis, MN (US)

(72) Inventors: RAGAVENDRAN M. V, Minneapolis, MN (US); MOHIT SETHI, Minneapolis, MN (US)

(21) Appl. No.: 18/155,689

(22) Filed: Jan. 17, 2023

(51) Int. Cl. G06F 9/50; G06F 9/48

(52) U.S. Cl. CPC G06F 9/5038; G06F 9/4881

(57) ABSTRACT

The present disclosure relates to a flexible computing resource cluster allocation system and method, wherein a user who needs to complete a task which requires an amount of computing power, may define a cluster of computing resources to complete the task via a local workspace. Clusters may be created in a computing platform (related to the enterprise or provided by a third party) according to the defined configuration details. A cluster may be created for a single task which is to be completed one time. After the task is complete, the resources that make up the cluster may be de-allocated automatically, and therefore returned to the platform to be available to be reallocated to another user. A user may also create recurring task that requires a certain amount of computing resources on a repeating basis.

### BACKGROUND

A user may need to complete a task which requires a large amount of computing resources, which the user does not normally have access to on his or her own personal or enterprise-issued computing system. Furthermore, an enterprise that the user is associated with may have some shared computing resources, but those resources may be only available upon request, which adds delay as information technology personnel within the enterprise would be required to allocate appropriate resources to the user in accordance with a known usage footprint and usage term. Even in this arrangement, where computing resources are available, reservation of those resources may be cumbersome. The user may require the computing resources on a one-time basis or on a periodic basis. For example, a user could require a particular amount of computing resources for a data enrichment job.

### SUMMARY

A user who needs to complete a task which requires a large amount of computing resources, which the user does not normally have access to on his or her own personal or enterprise-issued computing system may via a provided user interface, quickly define a cluster of computing resources accessible via a local workspace for that user (e.g., on his or her personal computing system) within an enterprise. This may simplify, for the user, the process of obtaining computing resources on which a project (e.g., a machine learning project) may be deployed. The system may provide a user interface by which the user can define a cluster of computing resources (for example, as a service) to complete the task. Accordingly, allocated computing resources may be readily defined by the user on an on-demand basis in a way that is specific to the task to be performed. Such resources may be accessible thereafter from the user's local computing system for isolated tasks or scheduled operations only during the time required.

In some aspects, a user may define a cluster configuration and may define any specific configuration details required. Clusters may be created in a computing platform (related to the enterprise or provided by a third party) according to the defined configuration details, with a determined start time. A cluster may be created for a single task which is to be completed one time, and then after the task is complete, the resources that make up the cluster may be de-allocated automatically, and therefore made available to be reallocated to another user. A user may also create a recurring task that requires a certain amount of computing resources on a repeating basis, and may choose a schedule for the recurrence (frequency, time, day(s) of the week).

Accordingly, the present application describes a computing system including at least one processor and at least one memory storing computer-executable instructions for defining a cluster of computing resources. The computer-executable instructions, when executed by the at least one processor, cause the computer to receive input data from a user interface accessible from a user computing device, the input data being associated with creating a cluster. The input data includes one or more of: a use case associated with the cluster; a run start time; a cluster data type; an amount of computing resources, including at least one of an amount of processing resources and an amount of memory; an environment in which to create the cluster; and a predetermined allocation category of the cluster. The instructions further cause the computer to prepare a cluster request associated with the input data and receive an image of an execution environment adapted for use according to the cluster request. The instructions further cause the computer to determine, based on the input data, whether to create the cluster using enterprise computing resource infrastructure or to create the cluster using a third party computing resource infrastructure, and to establish a connection with a provider of a chosen computing resource infrastructure, the chosen computing resource infrastructure being selected from among the enterprise computing resource infrastructure and the third party computing resource infrastructure. The instructions further cause the computer to utilize the image of the execution environment to create clusters with the chosen computing resource provider. Creating clusters may include assigning an amount of computing resources equal to or greater than the amount of computing resources defined within the input data; scheduling the cluster to run the use case at the run start time; and preparing IP addresses of nodes of the chosen computing resource provider grouped into clusters. The instructions further cause the computer to utilize the cluster to run the use case, wherein running the use case includes calling a script.

The present application further describes a computing system, including at least one processor and at least one memory storing computer-executable instructions for defining a cluster of computing resources as a service. The computer-executable instructions, when executed by the at least one processor, cause the computer to receive input data from a user, via a software development kit, the input data being associated with creating a cluster. The input data includes one or more of a platform designation; a use case associated with the cluster; an owner designation; a cluster data type; an environment in which to create the cluster; and a predetermined allocation category. The instructions further cause the computer to prepare a cluster request associated with the input data and receive an image of an execution environment adapted for use according to the cluster request. The instructions further cause the computer to determine, based on the platform designation, whether to create the cluster using an enterprise computing resource infrastructure or to create the cluster using a third party computing resource infrastructure, and to establish a connection with a provider of a chosen computing resource infrastructure, the chosen computing resource infrastructure being selected from among the enterprise computing resource infrastructure and the third party computing resource infrastructure. The instructions further cause the computer to utilize the image to create clusters with the chosen computing resource provider. Creating clusters may include assigning an amount of computing resources consistent with the predetermined allocation category; scheduling the cluster to run the use case at a run start time; and preparing IP addresses of nodes of the computing resource provider grouped into clusters. The instructions further cause the computer to utilize the cluster to run the use case, wherein running the use case includes calling a script. The instructions further cause the computer to determine that the cluster has not been utilized to run a second use case for a predetermined period of time and automatically decommission the cluster to release the amount of computing resources to the chosen provider.

The present application further describes a method, including receiving a request to create a cluster from a user interface, where the request includes input data. The input data includes one or more of a use case associated with the cluster; a run start time; a cluster data type; an amount of computing resources required; an environment in which to create the cluster; and a predetermined allocation category of the cluster. The request may then be stored. An image may be received, where the image is of an execution environment adapted for use according to the request. A resource provider is selected from among a plurality of different resource providers on which to create the cluster. A connection is established with an application programming interface associated with the selected resource provider. A set of commands is generated. The set of commands may include a creation command to create a cluster based on the image (creating a cluster may include assigning an amount of computing resources equal to or greater than the amount of computing resources required; scheduling the cluster to run the use case at the run start time; and preparing IP addresses of nodes of the selected resource provider grouped into clusters); a status command to receive a cluster status; and a detail command to receive one or more details of the cluster. The set of commands is issued to the application programming interface associated with the selected resource provider. In response to the application programming interface executing the set of commands, the cluster is utilized to run the use case, where running the use case includes calling a script.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 illustrates an example system for defining a cluster of computing resources, according to an example.

FIG. 2 further illustrates the example system of FIG. 1, according to an example.

FIG. 3 illustrates an example logical diagram of interactivity between a user computing device and a cluster of computing resources allocated for use by that user and user computing device, in accordance with aspects of the present disclosure.

FIG. 4 illustrates a schema for tracking deployment of clusters of computing resources in an on-demand environment, in accordance with aspects of the present disclosure.

FIG. 5 illustrates an example message flow diagram among components of a system for managing clusters of computing resources, in accordance with example aspects of the present disclosure.

FIG. 6 illustrates an example method for defining a cluster of computing resources, according to an example.

FIG. 6A illustrates an example method for creating a cluster of computing resources, according to an example.

FIG. 7 illustrates an example method for defining a cluster of computing resources, wherein input data is received from a user via a software development kit, according to an example.

FIG. 8 illustrates an example method for defining a cluster of computing resources, wherein a set of commands is issued to an application programming interface associated with a resource provider, according to an example.

FIG. 9 illustrates a user interface dashboard for monitoring and creating jobs, according to an example.

FIG. 10 illustrates further features of the user interface dashboard of FIG. 9, according to an example.

FIG. 11 illustrates a user interface for creating a job, according to an example.

FIG. 12 illustrates a user interface for scheduling a job, according to an example.

FIG. 13 illustrates a user interface dashboard for monitoring and creating clusters, according to an example.

FIG. 14 illustrates a user interface for creating a cluster, according to an example.

FIG. 15 illustrates an example block diagram of a computing system.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Examples may be practiced as methods, systems, or devices. Accordingly, examples may take the form of a hardware implementation, an entirely software implementation, or an implementation combining software and hardware aspects. The following detailed description is therefore not to be taken in a limiting sense, and the scope of the present disclosure is defined by the appended claims and their equivalents.

In accordance with the present disclosure, a user may need to complete a task which requires a large amount of computing power, which the user does not normally have access to on his or her own personal or enterprise-issued computing system. The user may require the computing resources on a one-time basis or on a periodic or recurring basis. For example, a user could require a particular amount of computing resources for a data enrichment job. In some examples, a data enrichment job may include detecting outliers or anomalies in one or more datasets, gathering insights from datasets, extracting variables from datasets, or other data processing tasks. In some examples, a data enrichment job may include training a machine learning/artificial intelligence model. In such an example, the model may be located on a user device and training data may be located on the device or in another storage location. The data enrichment job may require significant memory and/or processing capabilities. For example, a data enrichment job may utilize a large set of data and a large memory to store and perform mathematical calculations used to obtain the desired results. In examples of the present disclosure, a system may allow the user temporary access to computing resources required to complete the task (for example, a data enrichment process) from the user's own device. The access to computing resources may be customized for the user, may be based on one or more preexisting templates of computing resources, and may be for one-time use or recurrent use based on the user's specific application. User interfaces may be presented to the user to assist with selection of appropriate options for allocation of appropriate cluster-based computing resources that are thereafter accessible to the user as though at that user's local computing device.

Such an arrangement has a number of advantages. For example, this disclosure may relate to a system that allows users to quickly define, via a user interface presentable to enterprise personnel who are not typically tasked with resource allocation (e.g., non-IT personnel), a cluster of computing resources accessible via a local workspace for that user (e.g., on his or her personal computing system) within an enterprise. This may simplify, for the user, the process of obtaining computing resources on which a project (e.g., a machine learning project), may be deployed, and may allow the user to execute a process directly from his/her local workspace that utilizes the allocated resources. Such an arrangement is particularly advantageous in enterprises that have data science personnel who regularly need one-time and periodic allocations of significant computing resources for limited time periods.

In general, a user interface may allow a user to create a supported cluster type from among a plurality of different cluster types. The user may define a cluster configuration, including an environment, region, the category (CPU, GPU, and RAM), or flavor (for example, medium) for each server group, as well as any specific configuration details required. This cluster group configuration detail may be stored and provided to a tool which may convert the request into a generic format, create a relationship among the user and cluster, and call a platform application programming interface (API) using a set of commands for creating a distributed cluster, receiving a cluster status, and receiving cluster details. The platform API may create server groups (containers) and prepare inventory of IP addresses for all nodes within the server group. The platform API may also prepare relationships between the cluster groups within the computing platform in which the cluster is created. The computing platform may then allocate and start containers with a provided runtime environment for each and trigger a distributed data processing service (in some examples, triggering a distributed data processing service may accessing include model training data or running a script).

A cluster may be created for a single task or job which is to be completed one time, and then after the task is complete, the resources that make up the cluster may be de-allocated from the user and made available to be reallocated to another user. A user may also create a task or job which may be recurring and requires a certain amount of computing resources on a repeating basis (for example, a task to compute weekly sales as well as append the same with historic table every Sunday). A user creating a job may define a number of executors, executor cores, drive cores, amount of executor memory and drive memory (e.g. computing resources), whether the process is batch or continuous, may point the job to the location of the model, may choose between different cluster types, and may choose a schedule (frequency, time, day(s) of the week).

In some examples, the user interface allows the user to select a template to be applied within the cluster to be allocated. The template may be selected from among any of a variety of different types of templates adapted for use with different data processing environments, e.g., streaming data, stored data, etc. That is, a template for stream or batch processing may be applied within the cluster to assist the user with particularized tasks for which the cluster is allocated (e.g., data enrichment) based on the specific footprint/type of the data used for that task.

This service may provide users with many benefits. For example, users may be provided quick access to create clusters of computing resources (e.g., computational resources, storage resources, etc.) without the user needing to have those resources available on their own device. The service links the cluster to the user device and provides the advantage for the user to offload the heavy computation task to a specifically allocated off-device cluster with requested computing resources. The service may also provide an enterprise which the user belongs to with an overall efficiency, because computing resources may be allocated to users only as the users need them for tasks and, in some examples, may not remain allocated (out of the reach of other users) when they are not actively allocated for a job or task. This may reduce the overall amount of computing resources that the enterprise needs to have available.

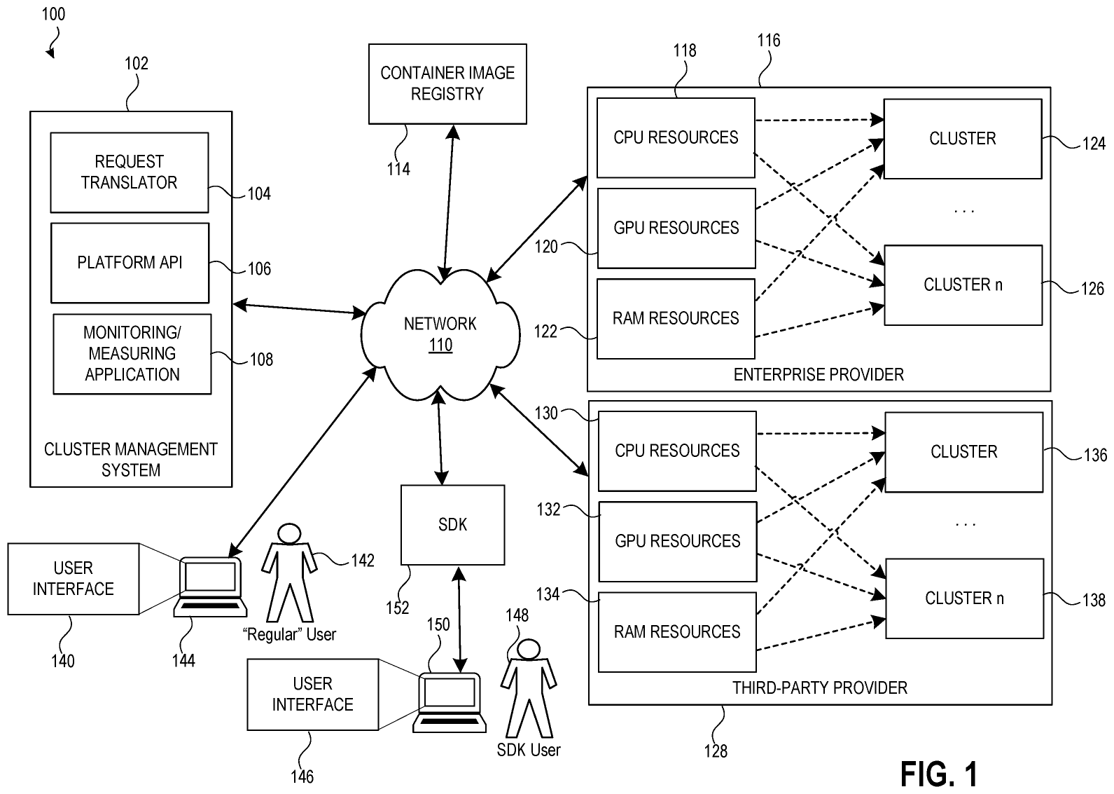

These and other examples will be explained in more detail below with respect to FIG. 1-FIG. 15.

FIG. 1 illustrates an example system 100 for defining a cluster of computing resources. As will be described in more detail below, the system 100 may include a cluster management system 102, request translator 104, platform application programming interface (API) 106, monitoring/measuring application 108, network 110, container image registry 114, enterprise provider 116 (which may include CPU resources 118, GPU resources 120, RAM resources 122, cluster 124, and cluster(s) n 126), third-party provider 128 (which may include CPU resources 130, GPU resources 132, RAM resources 134, cluster 136, and cluster(s) n 138), user interface 140, regular user 142, device 144, user interface 146, SDK user 148, device 150, software development kit (SDK) 152, and network 154.

In an example, cluster management system 102 may include request translator 104, platform application programming interface (API) 106, and monitoring/measuring application 108. In some examples, cluster management system 102 may receive input data from, or may output data to: cluster manager 112, container image registry 114, enterprise provider 116, third-party provider 128, device 144, device 150, and software development kit (SDK) 152, as will be discussed herein. The various input data and/or output data may be communicated via network 110.

In some examples, as described herein, network 110 may include a computer network, an enterprise intranet, the Internet, a LAN, a Wide Area Network (WAN), wireless transmission mediums, wired transmission mediums, other networks, and combinations thereof. Although network 110 is shown as a single network in FIG. 1, this is shown as an example and the various communications described herein may occur over the same network or a number of different networks.

In an example, cluster management system 102 may be configured to receive information regarding cluster and/or job creation from a user interface such as user interface 140 or user interface 146. As described in further detail below, information received may include cluster type (for example, a type of data that is to be processed within the cluster and an associated tool for processing such data, such as Apache Spark or Flink used for batch and streaming data, respectively), a run time, and other inputs. Cluster management system 102 may be configured to define a cluster configuration for the cluster to be created and may be configured to prepare a cluster request.

In an example, request translator 104 may be configured to receive information regarding the cluster and/or cluster request and may be configured to convert the cluster request into a generic format. In some examples, converting the cluster request into a generic format may include receiving an image of a cluster or platform established within a virtual execution container from container image registry 114. In examples, the image can be a templated container image that corresponds to the topology/format of the cluster request. In an example, container image registry 114 includes a plurality of such container images, for each of a variety of cluster types. In some examples, request translator 104 may be configured to store information related to the cluster in a relevant database, for example as an object or metadata file. Request translator 104 may call platform API 106 with instructions to create the cluster corresponding to the cluster request and gather the cluster information (including cluster status and cluster detail). In an example embodiment, request translator 104 may be implemented using the Polyhistor tool useable for request translation and interfacing with a cluster deployment environment. Other example request translators may be used as well.

In an example, platform API 106 may receive the cluster request. Platform API 106 may be configured to prepare an inventory of IP addresses of nodes to be assigned to the cluster. Nodes may be grouped by server-group. Platform API 106 may be configured to prepare relationships between cluster groups. Platform API 106 may be configured to call a provider API (for example, a provider API associated with enterprise provider 116 or third-party provider 128) to create the cluster and start the cluster.

In an example, monitoring/measuring application 108 may monitor the cluster, which may include monitoring the status of the cluster, monitoring the usage of the cluster, measuring the performance of the cluster, and/or measuring the utilization of the cluster, among other factors.

In an example, enterprise provider 116 and/or third-party provider 128 may each be a provider of computing resources, such as CPU resources 118, 130, GPU resources 120, 132, RAM resources 122, 134, and other computing resource types (for example, including various memory types). In some examples, a cluster 124, 136 may be created, and the cluster 124, 136 may include computing resources of one or more types. In an example, more than one cluster n 126, 138 is created to utilize the computing resources. In an example, enterprise provider 116 is associated with or is within the same enterprise to which the cluster management system 102 is associated with. In an example, third-party provider 128 is associated with or is within a different, third-party enterprise. In an example, each of enterprise provider 116 and/or third-party provider 128 may include a provider API, which may be configured to receive inputs from the cluster management system 102.

In an example, regular user 142 is an employee, operator, manager, or other agent of the enterprise. Regular user 142 may have a need to create and utilize a cluster of computing resources, and may communicate information relating to the desired cluster into user interface 140, via device 144. In some examples, information from user interface 140 may be received by cluster management system 102. In some examples, regular user 142 may communicate information relating to the desired cluster into interface 140, where interface 140 presents a graphical user interface. In some examples, regular user 142 may communicate information relating to the desired cluster into interface 140, where interface 140 presents a command-line interface (CLI).

In an example, SDK user 148 is an employee, operator, manager, or other agent of the enterprise, with more advanced computer knowledge and/or programming capability (for example, a developer). SDK user 148 may have a need to create and utilize a cluster of computing resources and may communicate information relating to the desired cluster into user interface 146, via device 150. In some examples, information from user interface 146 may be received by cluster management system 102. In some examples, information from user interface 146 may be received by a software development kit (SDK) 152 installable on or deployable to the user device 150, and cluster management system 102 may receive information from SDK 152.

In an example, user interface(s) 140, 146 is a web application. In other examples, user interface(s) 140, 146 is a device application.

In some examples, devices 144, 150 may be a desktop computer, a laptop computer, a tablet, a cell phone, a smart TV, a smart wearable device, or other appropriate electronic device which is capable of displaying and facilitating interaction with the user interface(s) 140, 146.

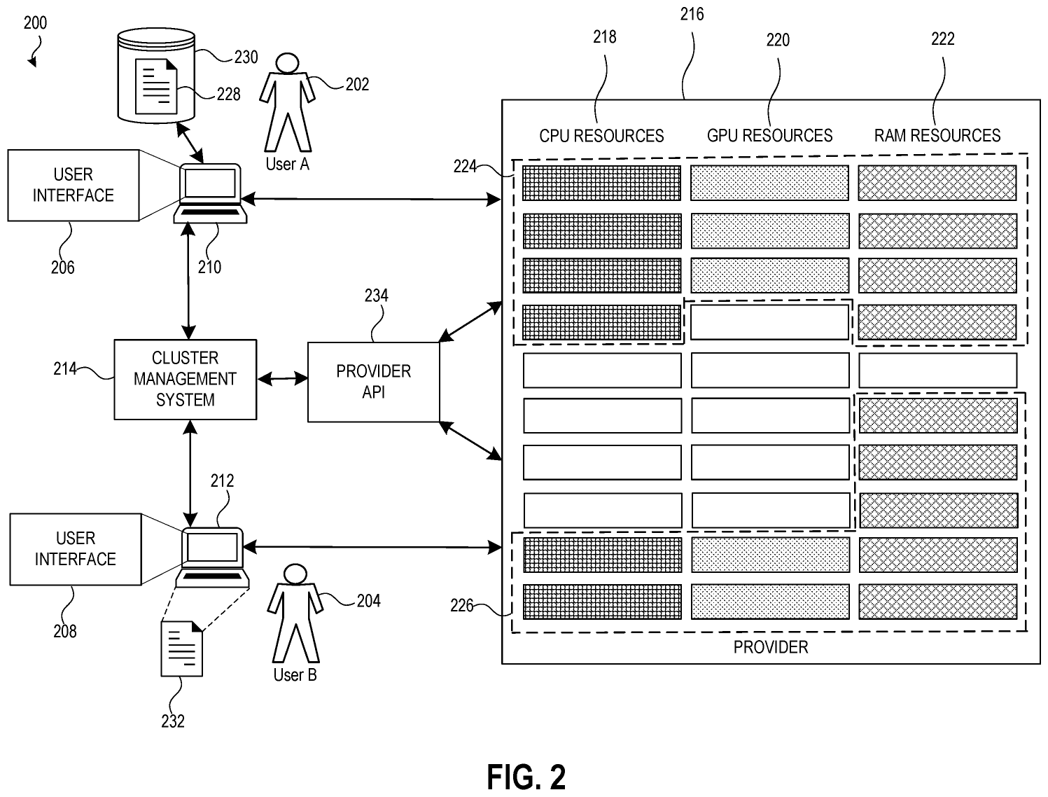

FIG. 2 further illustrates an example system 200 for defining a cluster of computing resources. As will be described in more detail below, the system 200 may include a user A 202, user B 204, user interface 206, user interface 208, device 210, device 212, cluster management system 214, provider 216 (which may include CPU resources 218, GPU resources 220, RAM resources 222, and other computing resources and, including memory resources), cluster A 224, cluster B 226, script 228, database 230, script 232, and provider API 234.

In some examples, user A 202 may have a need to create and utilize a cluster of computing resources. In some examples, user A 202 is an example of regular user 142 or SDK user 148. User A 202 may input information regarding the needed resources and the use case for the resources into user interface 206 via device 210, as will be described in more detail below. In some examples, device 210 is an example of device 144 or device 150. In some examples, user interface 206 is an example of user interface 140 or user interface 146. Input information may include an amount of one or more of each of several different types of computing resources necessary to complete the use case, as well as a type of cluster to be created. In some examples, the input information is received by a cluster management system 214 configured to generate a cluster request. In some examples, cluster management system 214 is an example of cluster management system 102.

In some examples, cluster management system 214 may relay the cluster request to the provider 216. In some examples, cluster management system 214 may relay the cluster request to the provider API 234, which is associated with provider 216. In some examples, provider API 234 may be within or external to provider 226. In some examples, provider 216 may be within or associated with the same enterprise as cluster management system 214 (for example, provider 216 may be an example of enterprise provider 116). In some examples, provider 216 may be associated with or within a third-party enterprise (for example, provider 216 may be an example of third-party provider 128).

In some examples, computing resources of provider 216 are grouped into containers and allocated to cluster A 224, consistent with the input information entered into user interface 206 by user A 202.

In some examples, after the cluster A 224 is created, a script 228 may be called to run the use case. In some examples, the script 228 may be stored in a git repository 230 or other storage location (for example, a database) outside of device 210.

In some examples, user B 204 may have a need to create and utilize a cluster of computing resources. In some examples, user B 204 is an example of regular user 142 or SDK user 148. User B 204 may input information regarding the needed resources and the use case for the resources into user interface 208 via device 212, as will be described in more detail below. In some examples, device 212 is an example of device 144 or device 150. In some examples, user interface 208 is an example of user interface 140 or user interface 146. Input information may include an amount of one or more of each of several different types of computing resources necessary to complete the use case, as well as a type of cluster to be created. In some examples, the input information is received by a cluster management system 214 configured to generate a cluster request.

In some examples, cluster management system 214 may relay the cluster request to the provider 216. In some examples, cluster management system 214 may relay the cluster request to the provider API 234.

In some examples, computing resources of provider 216 are grouped into containers and allocated to cluster B 226, consistent with the input information entered into user interface 208 by user A 204.

In some examples, after the cluster B 226 is created, a script 232 may be called to run the use case. In some examples, the script 230 may be stored on device 212.

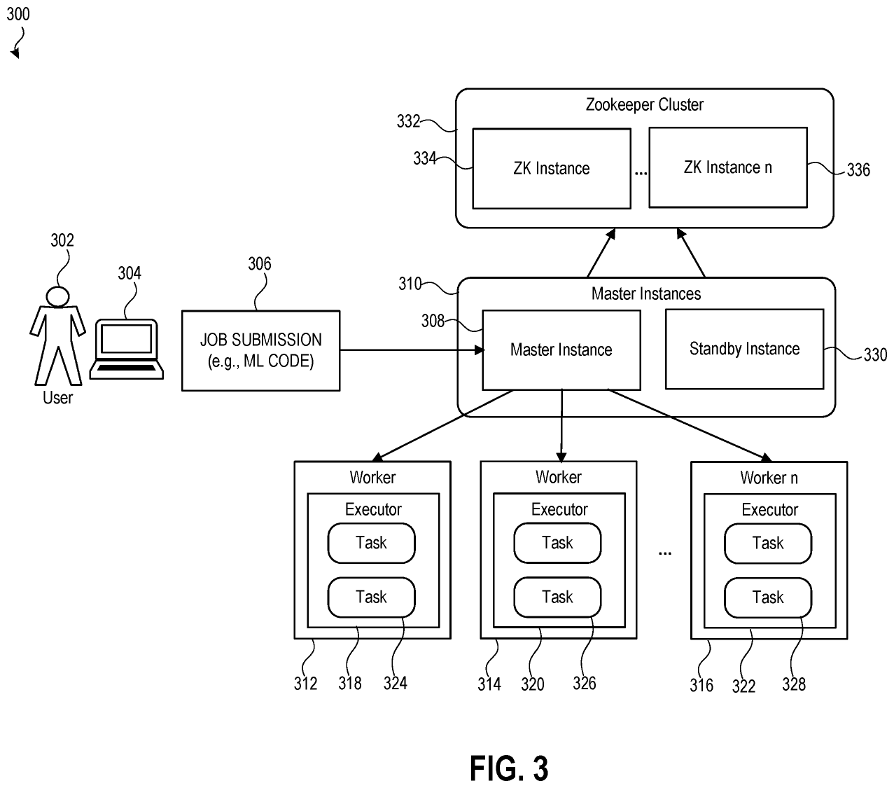

FIG. 3 illustrates an example logical diagram of interactivity between a user computing device and a cluster of computing resources allocated for use by that user and user computing device, in accordance with aspects of the present disclosure. The logical diagram represents an example use case of the cluster management system described herein.

In the example shown, a user 302 may via his or her user computing device 304, define a job to be submitted 306 (a data enrichment job) for execution via a cluster of computing resources. In examples, the job for submission 306 may be a job configured for training of a machine learning (ML) model, performing various extract, transform, and load (ETL) operations, varying batch processing, large data querying, data streaming, data lake management, or other tasks. In the examples described herein, use of a cluster for machine learning is described as a working example.

Generally speaking, the user 302 may submit his or her job submission 306, which may include a definition of the cluster unto which the job is to be executed, as well as a definition of the template used for the cluster and the code to be executed on that cluster. Details regarding definition of the cluster are provided below. In the example shown, the job submission 306 may be submitted to a master instance 308, which corresponds to a master container 310 that controls one or more sub-task, or worker containers 312, 314, 316. Each worker 312, 314, 316 will host an executor 318, 320, 322, which corresponds to the execution resources associated with each worker 312, 314, 316 in the cluster. Each worker 312, 314, 316, and therefore each executor 318, 320, 322, may execute a task as part of the overall job, as distributed by the master instance 308.

In the example shown, one or more master instances 308 may be provided, including the primary master instance 308 as illustrated, as well as one or more standby instances 330, in the event of failure of the master instance 308. Additionally, a zookeeper cluster 332 may maintain one or more additional node instances 334, 336 that may be allocated to different user clusters on demand.

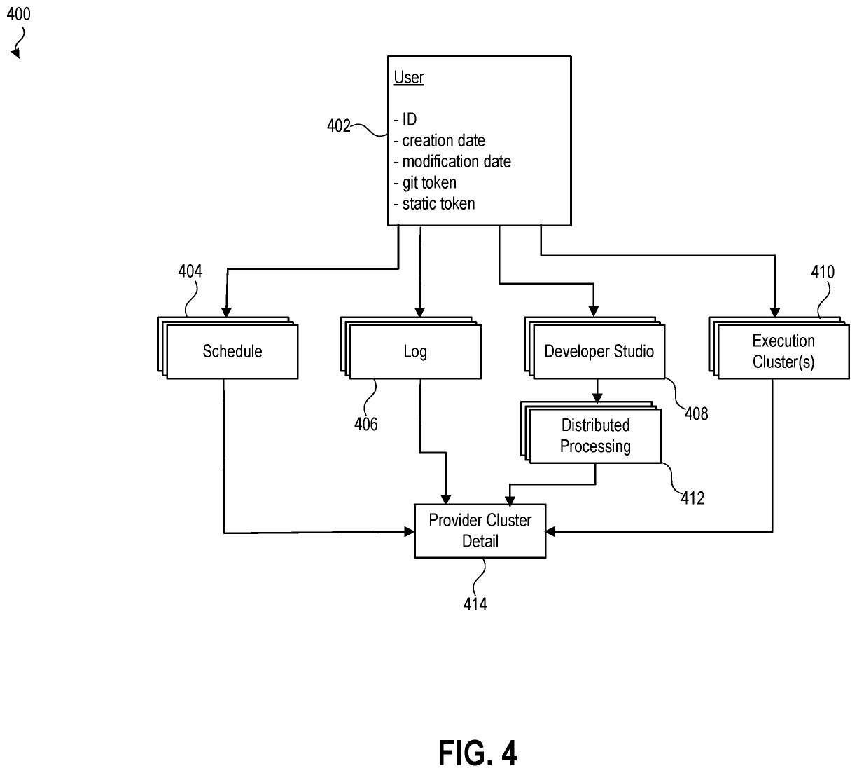

FIG. 4 illustrates a schema for a database 400 for tracking deployment of clusters of computing resources in an on-demand environment, in accordance with aspects of the present disclosure. The schema may be stored, for example, within a database maintained by the cluster management system 102, 214, as described above in conjunction with FIGS. 1-2.

In the example shown, the systems described herein may track each of the user defined clusters using a database 400 including a plurality of tables, including a user cluster table 402, which can include a variety of defined cluster characteristics, including a cluster ID, a creation date, a modification date, a token associated with a particular code repository from which code may be executed (e.g., a GIT token), and one or more static tokens usable for reference to the cluster. The user cluster table 402 may be linked to one or more job tables. The job tables may be configured for running jobs on the created clusters. The user cluster table 402 may be linked to one or more schedule tables 404, one or more log tables 406, one or more developer studio tables 408, and one or more cluster tables 410. In some examples, schedule tables 404 maintain scheduling information about the cluster creation and about task to be executed (for example, when a particular job or task is to be run). In some examples, log tables 406 maintain information about the cluster and its creation, the task or job executed, and the decommissioning of the cluster. The developer studio tables 408 maintain information regarding one or more developer environments (e.g. code editing application environments) in which, for example, machine learning model code may be written. The one or more cluster tables 410 maintain information regarding the one or more clusters currently in use by various users.

In the example shown, each developer studio entry in the developer studio tables 408 may be associated with a corresponding distributed processing entry 412, which defines a distributed task. The models, model training information, distributed tasks, and cluster information may be tied to a definition of a particular infrastructure provider cluster 414 (e.g., a cluster formed within a particular selected infrastructure from among a plurality of different, selectable infrastructure providers.

Using the database 400, the system 100 described herein can track different clusters of computing resources that are allocated according to user demand, and issue definitions at the time required to create clusters, deploy jobs to clusters, and link to user environments to execute desired tasks.

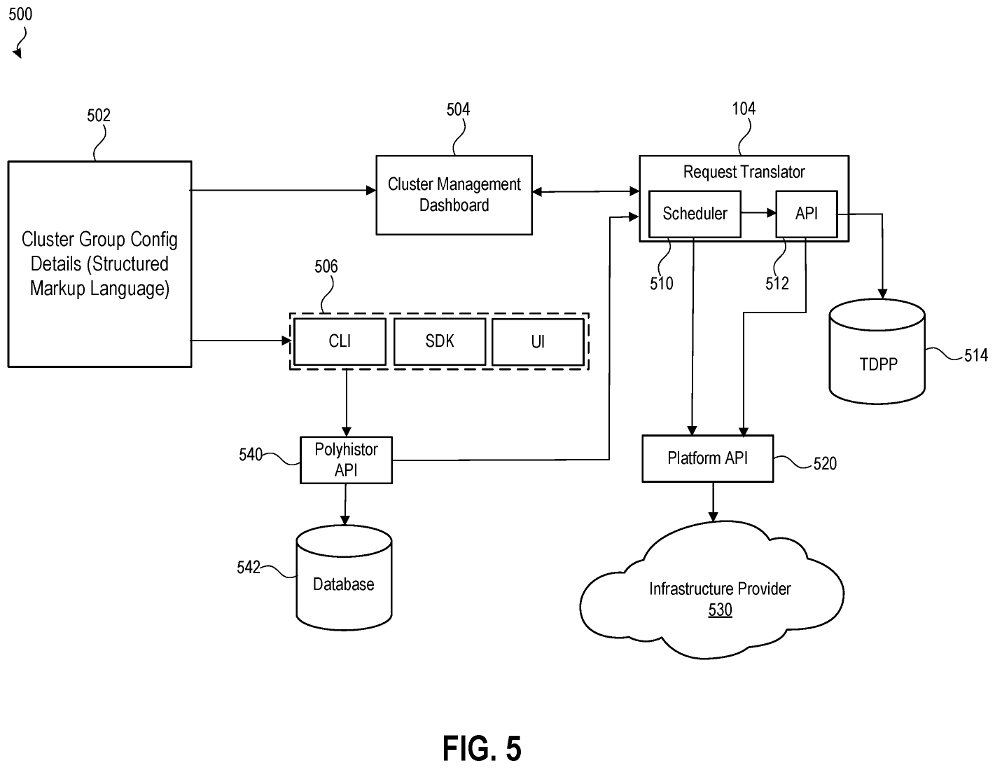

FIG. 5 illustrates an example message flow diagram 500 among components of a system for managing clusters of computing resources. The message flow diagram 500 includes transmission of a cluster group configuration detail 502 to a cluster dashboard 504, as well as to a plurality of user interface services 506. The cluster group configuration details 502 may be formed in a structured markup language and may include a definition of a number of cluster instances, a cluster flavor, a configuration of number of master and slave containers within a cluster, a particular runtime environment type, and a cluster type. Other types of characteristics of the cluster may be provided as well. The user interface services 506 may receive the definition of a cluster and may pass that definition to a polyhistor API 540 that forms a request. In some examples, polyhistor API 540 may be representative of a core API. In some examples, a polyhistor API 540 may be representative of a microservice responsible for serving user-facing requests. The microservice may accept a request for creating a cluster, submitting a job, creating a schedule, receiving cluster and job details, and may perform other functions. The microservice may interact with other services such as the platform API 520.

The polyhistor API 540 is integrated with a request translator 104, which includes a scheduler 510 and an API 512. The request translator 104 receives the cluster group configuration detail 502, and the scheduler 510 provides a cluster status and detail to a platform API 520. The API 512 of the request translator 104 can issue a cluster creation request to the API 520, in addition to updating a cluster status within a status tracking database (TDPP) 514. The platform API 520 issues commands to a selected infrastructure provider 530 (e.g., by a provider API 234, as described above) from among a plurality of selectable infrastructure providers to create the underlying infrastructure clusters required to implement the selected cluster deployment.

In the example shown, the polyhistor API 540 also stores details of the requested cluster configuration 502 in a database 542, in addition to forwarding cluster creation request details to the request translator 104. The cluster dashboard 504 integrates with the request translator 104 to receive and display cluster execution status and statistics as needed by a user (e.g., the same user who submitted the request, or an administrative user).

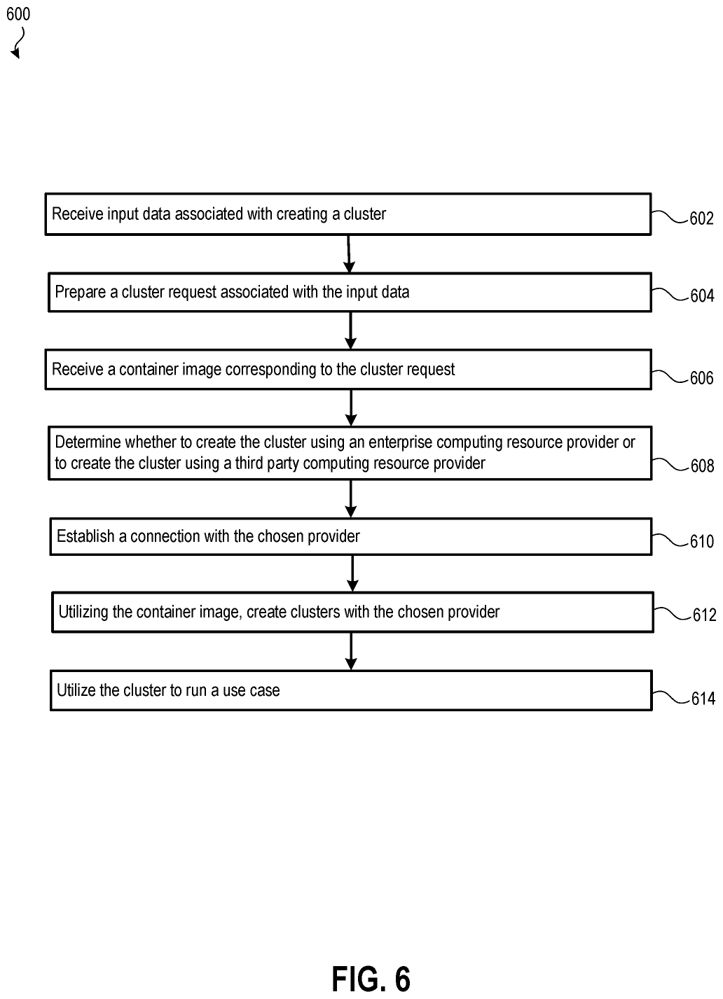

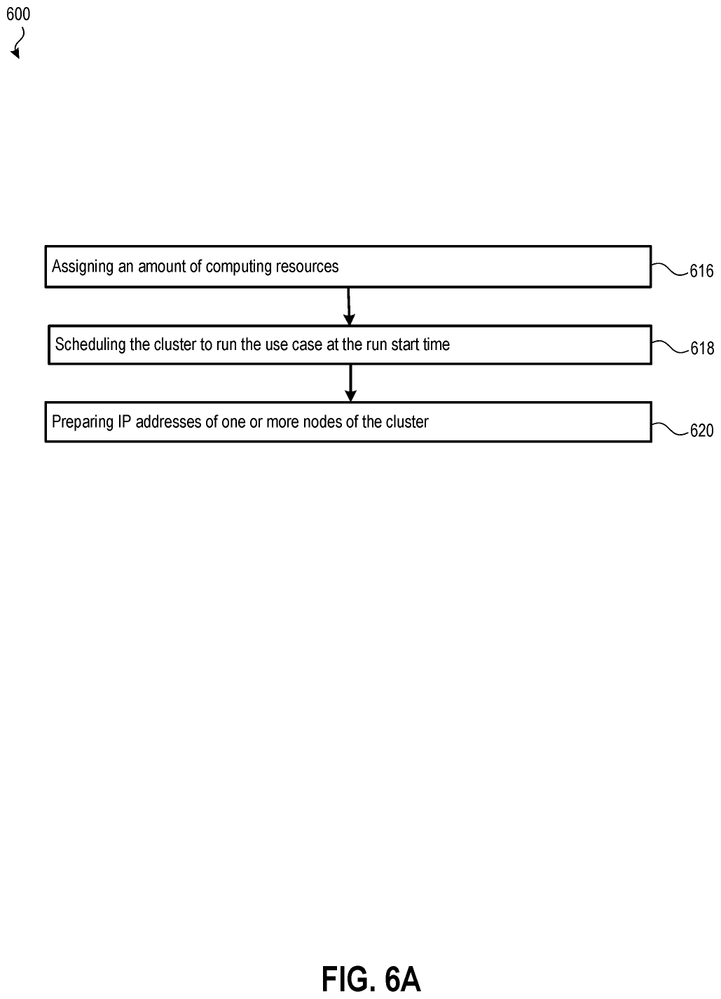

FIG. 6 illustrates an example method for defining a cluster of computing resources. The method 600 may be performed by one or more systems shown and described with respect to at least FIG. 1-FIG. 5.

At step 602, input data may be received from a user interface, such as a user interface provided within the user interface services 506. The user interface may be accessible from a user computing device, such as user computing device 304. The input data may be associated with creating a cluster (which may in some examples, be associated with creating a job). The input data may include: a use case associated with the cluster and/or job; a run start time; a cluster data type; an amount of computing resources required (for example, amounts of one or more different types of computing resources or memory required); an environment in which to create the cluster; and a predetermined allocation category of the cluster. The amount of computing resources required (or requested) may include an amount of processing resources and/or an amount or memory.

At step 604, a cluster request is prepared which is associated with the input data. The cluster request may be prepared by an API, such as polyhistor API 540, for submission to a request translator 104.

At step 606, a container image corresponding to one or more containers required to implement the cluster request is received. The container image may be of an execution environment adapted for use according to the cluster request. In some examples, the container image may be received from a container image registry such as container image registry 114, which includes a plurality of container images from which the received container image is selected. In some examples, the container image may be implemented as a docker image, and may be received from a docker image registry, which includes a plurality of docker images from which the received docker image is selected.

The cluster request may be converted into a generic format as described above, by the request translator 104, prior to obtaining the container image(s). The request translator 104 may also retrieve appropriate images for deployment to a particular cluster via the platform API 520 described above.

At step 608, a determination is made, based at least in part on the input data, whether to create the cluster using an enterprise computing resource infrastructure or whether to create the cluster using a third-party computing resource infrastructure. Considerations may include the amount and types of computing resources necessary to create the cluster and/or to run the use case, sensitivity or confidentiality of the use case, capability and/or resource availability of the provider, and others.

At step 610, a connection with a provider of the chosen computing resource infrastructure is established. The chosen computing resource infrastructure is selected from among the enterprise computing resource infrastructure and the third-party computing resource infrastructure. In some examples, the connection is made between a platform API 106 and a provider API 234.

At step 612, utilizing the container image(s) of the execution environment, clusters are created at the chosen computing resource provider. In some examples, referring to FIG. 6B, creating the clusters of computing resources may include: At step 616, assigning an amount of memory, number of processing cores, storage area, processing core types, and the like (e.g., computing resources) equal to or greater than the amount of resources that are required, defined, and/or requested within the input data; at step 618, scheduling the cluster to run the use case at the run start time; and at step 620, preparing IP addresses of one or more nodes of the cluster (e.g., at least a master node, or in some instances, all nodes, of the chosen computing resource provider grouped into clusters).

Returning to FIG. 6, at step 614, the cluster may be utilized to run the use case (or job) and running the use case may include calling a script or other code. In some examples, the script may be called from a user device, and may be local to the user device, or may be at a remote path. For example, a job submission (use case) 306 may be called from a user computing device 304 as described above. The input data may include a user device path pointing to the script or code. In some examples, the script may be called from a database or other storage source such as a GIT repository. The input data may include a location path pointing to the script.

In some examples, performance of the cluster (or associated job) may be monitored and/or measured before, after, and/or during the time when the cluster is running the use case. Cluster status may be monitored. In some examples, performance/status may be monitored from a monitoring/measuring application 108 within the cluster management system 102. In some examples, performance/status may be monitored by an application external to cluster management system 102. Monitored/measured information regarding the cluster may be provided to a user, e.g., via a cluster management dashboard 504, as described above. In some examples, monitored/measured information may be displayed on a dashboard interface.

In some examples, the amount of memory, number of processing cores, and/or other computing resources assigned to the cluster may be changed, based on edited inputs received from a user via the dashboard user interface. For example, user 142 may make a change via user interface 140 which indicates that a number of computing resources allocated to the cluster should be changed.

In some examples, it may be determined, based on the monitored performance of the cluster (for example, from monitoring/measuring application 108), that a measured actual amount of computing resources being utilized to run the use case is lower than the amount of a particular computing resource which was required/requested to run the use case by the input data. In response to that determination, the amount of that computing resource assigned to the cluster may then be decreased, to thereby free up (e.g., deallocate) those resources at the particular provider. In particular, especially for finite collections of enterprise-controlled resources, this may enable allocation of those resources to another cluster, while also avoiding degradation of performance of the original cluster.

In some examples, it may be determined, based on the monitored performance of the cluster (for example, from monitoring/measuring application 108), that a measured actual amount of a particular computing resource being utilized to run the use case is equal to the amount of that computing resource which was required/requested to run the use case by the input data, and that the measured actual amount of the resource is insufficient to run the use case. In response to that determination, the amount of the computing resources assigned/allocated to the cluster may be increased (so long as it is available within the provider) to increase the performance of the cluster and to ensure the use case is adequately run.

In some examples, it may be determined that the use case has been run to a completion point (for example, from monitoring/measuring application 108), and, upon reaching or surpassing the completion point, the collection of computing resources assigned to the cluster may be automatically deallocated from the cluster (in some examples, the cluster may be decommissioned) and released to the chosen provider, so that it may be free for allocation to another cluster or another use.

In some examples, if the use case and/or input information from the user interface (for example user interface 140) indicates that the use case is a reoccurring job, the cluster may be scheduled to automatically run the use case at least at a second run start time. In some examples where the cluster is associated with a recurring job, after running the use case, it may be determined that the use case has been run to a completion point and the amount of memory (or other computing resources) assigned to the cluster may be temporarily reallocated/released to the chosen provider until the subsequent run start time. A second instance of the cluster may be created according to the input data from which the first instance of the cluster was created. At or prior to the second run start time, the required computing resources may be reallocated to a (second instance of the) cluster associated with the user as defined by the request, and the cluster may be utilized to automatically run the use case at the second or subsequent run start time.

In another example, if the use case and/or input information from the user interface (for example, user interface 140) indicates that the use case is a reoccurring job, at or prior to the second run start time, the required computing resources may be reallocated to a second instance of the cluster (associated with the user as defined by the request and created according to the input data from which the first instance of the cluster was created). The second instance of the cluster may be scheduled to automatically run the use case at the second run start time, and the cluster may be utilized to automatically run the use case at the subsequent run start time.

For example, the use case may include training or re-training an artificial intelligence model. Input data may indicate this use case and may point to the location of the model script to be trained. In some examples, the input data may point to the location of data to be used to train/retrain the model. In an example of a recurring job, the training data may be updated on a periodic basis (for example, every Monday and Wednesday). The input data may indicate that the recurring job must re-run every Tuesday morning and Thursday morning to retrain the model with the most updated training data.

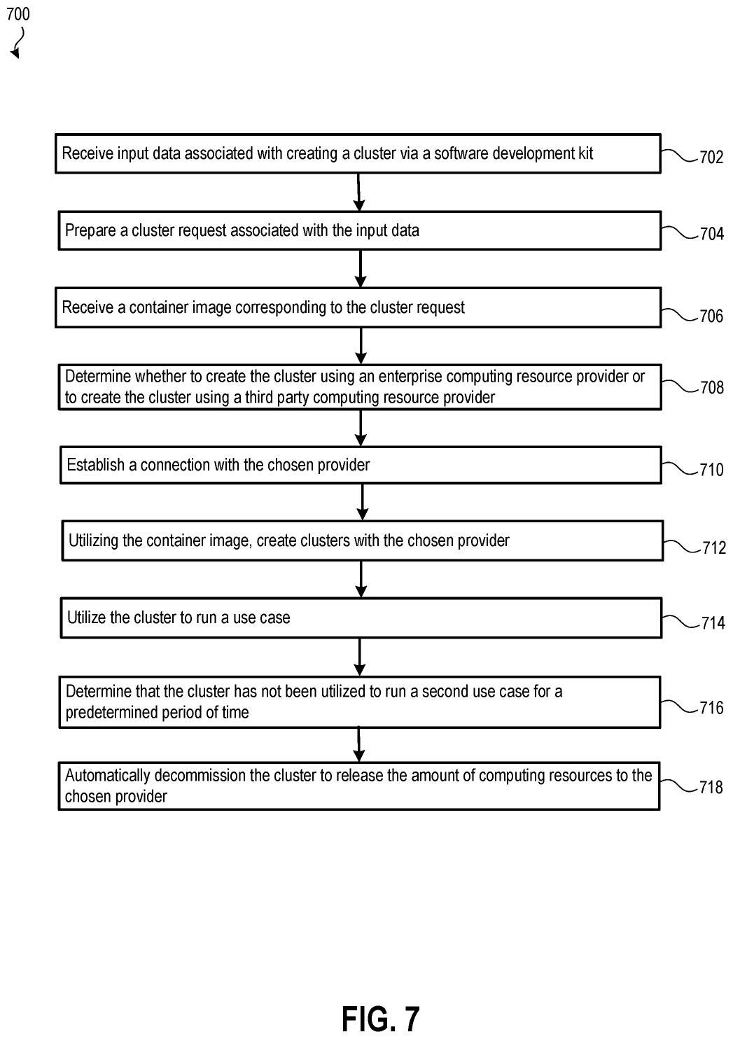

FIG. 7 illustrates an example method 700 for defining a cluster of computing resources, wherein input data is received from a user via a software development kit. The method 700 may be performed by one or more systems shown and described with respect to at least FIG. 1-FIG. 5.

At step 702, input data may be received from a user, for example via a software development kit (SDK) such as SDK 152. The input data may be associated with creating a cluster. The input data may include: a use case associated with the cluster and/or job; a platform designation; a cluster data type; an owner designation; an amount of memory required (for example, amounts of one or more different types of computing resources required); an environment in which to create the cluster; and a predetermined allocation category of the cluster.

At step 704, a cluster request is prepared which is associated with the input data. The cluster request may be prepared by an API, such as polyhistor API 540, for submission to a request translator 104.

At step 706, a container image corresponding to the cluster request is received. In some examples, the container image may be of an execution environment adapted for use according to the cluster request. In some examples, the container image may be received from a container image registry such as container image registry 114, which includes a plurality of container images from which the received container image is selected. In some examples, the container image may be implemented as a docker image, and may be received from a docker image registry, which includes a plurality of docker images from which the received docker image is selected.

The cluster request may be converted into a generic format as described above, by the request translator 104, prior to obtaining the container image(s). The request translator 104 may also retrieve appropriate images for deployment to a particular cluster via the platform API 520 described above.

At step 708, a determination is made, based at least in part on the input data, whether to create the cluster using an enterprise computing resource infrastructure or whether to create the cluster using a third-party computing resource infrastructure. Considerations may include the amount and types of computing resources necessary to create the cluster and/or run the use case, sensitivity or confidentiality of the use case, capability and/or resource availability of the provider, and others.

At step 710, a connection with a provider of a chosen computing resource infrastructure provider is established (for example, enterprise provider 116 or third-party provider 128). The chosen computing infrastructure is selected from among the enterprise computing resource infrastructure and the third-party computing resource infrastructure.

At step 712, utilizing the container image, clusters are created within the chosen computing resource provider. For example, clusters may be created according to a request processed by an API such as API 512, and by a series of commands issued to the chosen provider through a provider API 234. In some examples, referring to FIG. 6A, creating the clusters of computing resources may include: at step 616, assigning an amount of memory, number of processing cores, storage area, processing core types, and the like (e.g. computing resources) equal to or greater than the amount of memory (e.g. computing resources) required; at step 618, scheduling the cluster to run the use case at the run start time; and at step 620 preparing IP addresses of one or more nodes of the cluster (e.g., at least a master node, or in some instances, all nodes). Notably, the specific commands issued to allocate resources within the chosen computing resource provider may vary across different providers. In particular, by accessing a provider API 234 of different providers, a common request format may be used, and may be translated into underlying allocation commands within the infrastructure of each provider.

Returning to FIG. 7, at step 714, the cluster may be utilized to run the use case (or job) and running the use case may include calling a script or other code. In some examples, the script may be called from a user device, and may be local to the user device, or may be at a remote path. For example, a job submission (use case) 306 may be called from a user computing device 304 as described above. The input data may include a user device path pointing to the script or code. In some examples, the script may be called from a database or other storage source such as a GIT repository. The input data may include a location path pointing to the script.

At step 716, it may be determined that the cluster has been idle. In some examples, it may be determined that the cluster has been utilized to run a second or subsequent use case for a predetermined period of time. In some examples, the data indicating that the cluster has been idle or the cluster utilization history may originate from monitoring/measuring application 108.

At step 718, the amount of memory allocated to the cluster may be deallocated from the cluster (automatically, in some examples), and returned/released as free resources to the chosen computing resources provider.

In some examples, the performance or status of the cluster may be monitored when the cluster is running the use case. In some examples, the performance or status of the cluster when the cluster is not running the use case may also be monitored. In some examples, performance/status may be monitored from a monitoring/measuring application 108 within the cluster management system 102. In some examples, performance/status may be monitored by an application external to cluster management system 102. In some examples, performance metrics associated with the monitored performance or status of the cluster may be output to a dashboard user interface e.g., via a cluster management dashboard 504, as described above. In some examples, monitored/measured information may be displayed on a dashboard interface.

In some examples, the user may interact with the dashboard user interface or another user interface, and the user may enter inputs into the dashboard user interface. The inputs may be associated with editing the amount of memory (computing resources) assigned to the cluster, deleting the cluster, starting a job on the cluster, or other edits to the cluster. Based on the edit inputs received from the user via the dashboard user interface, the amount of memory (computing resources) assigned to the cluster may be changed (increasing or decreasing the amount of one or more types of computing resources allocated to the cluster).

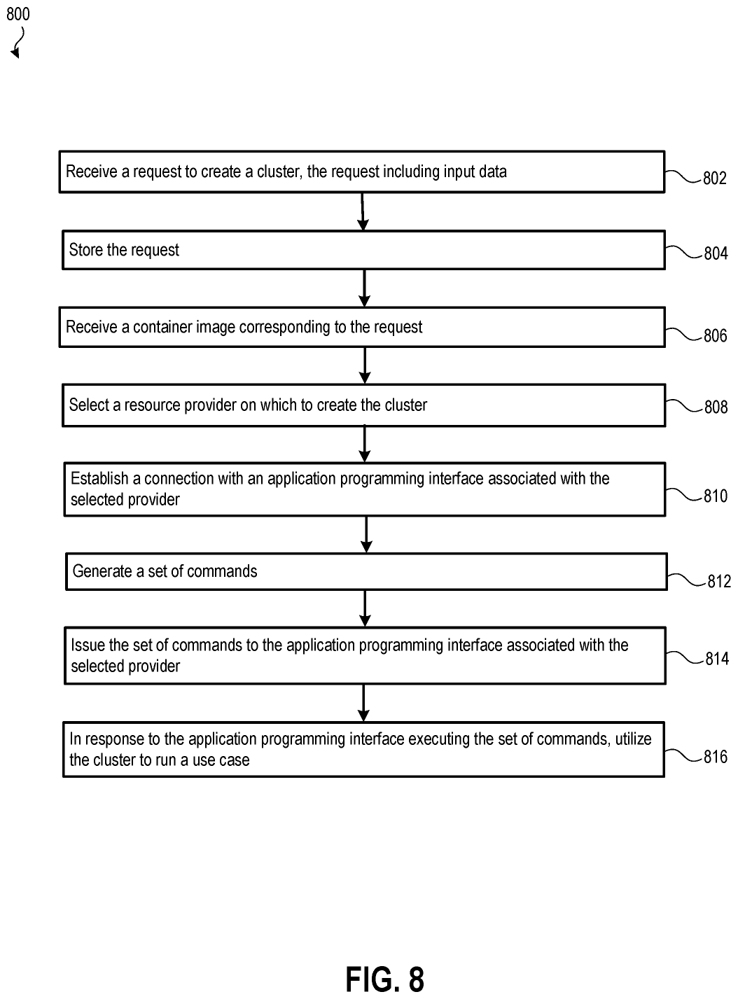

FIG. 8 illustrates an example method 800 for defining a cluster of computing resources, wherein a set of commands is issued to an application programming interface associated with a resource provider. The method 800 may be performed by one or more systems shown and described with respect to at least FIG. 1-FIG. 5.

At step 802, a request to create a cluster may be received from a user interface. The request may include input data, which may include: a use case associated with the cluster; a run start time; a cluster data type; an amount of memory (for example, an amount of one or more types of computing resources) required; an environment in which to create the cluster; and a predetermined allocation category (for example, a predetermined size or layout of cluster including a predetermined amount of each of one or more computing resources, and having a category designation such as small, medium, large, etc.) of the cluster.

At step 804, the request may be stored. In some examples, the request and/or details associated with the cluster configuration may be stored in a database such as database (MLP) 542. In some examples, the request and/or details associated with the cluster configuration may be stored in a database such as status tracking database (TDPP) 514.

At step 806, a container image corresponding to the cluster request is received. In some examples, the container image may be received from a container image registry such as container image registry 114, which includes a plurality of container images from which the received container image is selected. The image may be of an execution environment adapted for use according to the request. In some examples, the container image may be implemented as a docker image, and may be received from a docker image registry, which includes a plurality of docker images from which the received docker image is selected.

The cluster request may be converted into a generic format as described above, by the request translator 104, prior to obtaining the container image(s). The request translator 104 may also retrieve appropriate images for deployment to a particular cluster via the platform API 520 described above.

At step 808, a resource provider may be selected from among a plurality of different resource providers on which to create the cluster. In some examples, the resource provider may be specified in the received input data. In some examples, the plurality of different resource providers may include at least one enterprise computing resources provider (for example, enterprise provider 116) and at least one third-party computing resources provider (for example, third-party provider 128).

At step 810, a connection with an application programming interface associated with the selected resource provider (such as provider API 234) may be established (in some examples, by platform API 520).

At step 812, a set of commands may be generated. The set of commands may include: a creation command to create a cluster based on the container image (wherein creating a cluster may include: assigning an amount of computing resources (in some examples, one or more types of memory) consistent with the predetermined allocation category; scheduling the cluster to run the use case at the run start time; and preparing IP addresses of nodes of the selected provider grouped into clusters); a status command to receive a cluster status (for example, whether or not the cluster has completed running the use case, or is actively running the use case, or is inactive); and a detail command to receive one or more details of the cluster (for example, performance characteristics of the cluster).

At step 814, the set of commands may be issued to the application programming interface associated with the selected provider (for example, provider API 234).

At step 816, in response to the application programming interface (for example, provider API 234) executing the set of commands, the cluster may be utilized to run the use case, wherein running the use case includes calling a script. In some examples, the script may be called from a user device. For example, a job submission (use case) 306 may be called from a user computing device 304 as described above. The input data may include a user device path pointing to the script. In some examples, the script may be called from a database or other storage source. The input data may include a database location path pointing to the script.

In some examples, the performance or status of the cluster may be monitored when the cluster is running the use case. In some examples, the performance or status of the cluster when the cluster is not running the use case. In some examples, performance/status may be monitored from a monitoring/measuring application 108 within the cluster management system 102. In some examples, performance/status may be monitored by an application external to cluster management system 102. In some examples, monitoring the performance of the cluster includes: sending an instruction to the application programming interface to measure cluster performance and/or status; receiving cluster performance information from the application programming interface; and outputting performance metrics associated with the cluster performance information to a dashboard user interface, where they may be viewed by a user.

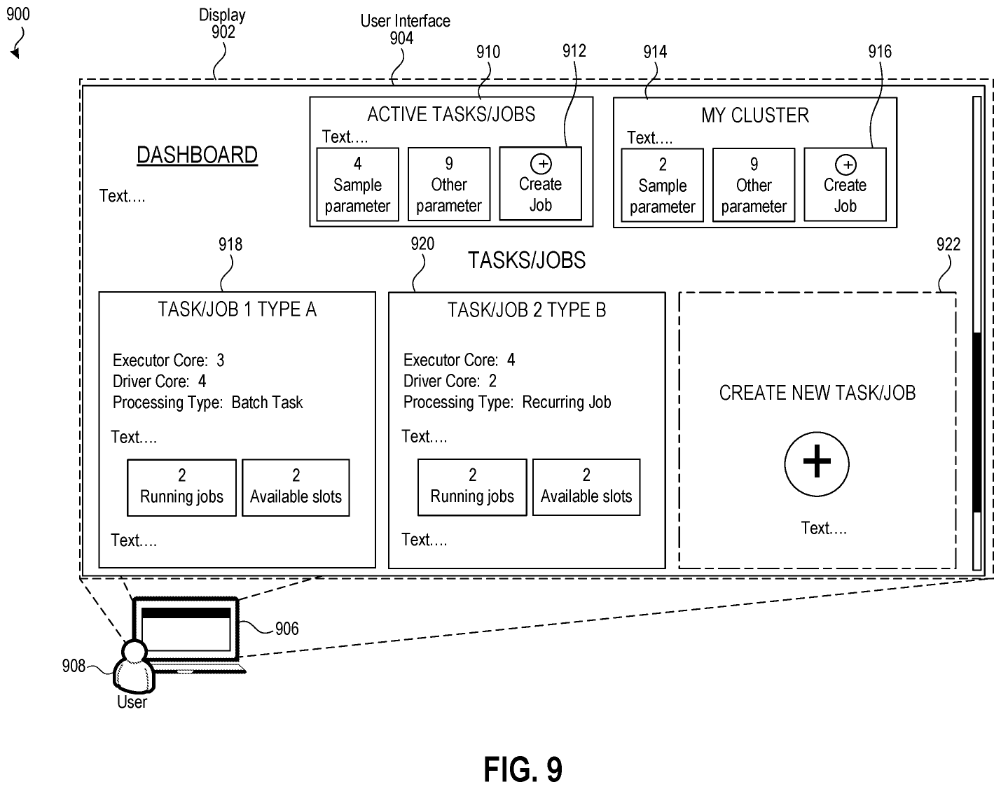

FIG. 9 illustrates a user interface dashboard for monitoring and creating jobs, according to an example. The user interface dashboard may be generated at the system 100, for example using user interface services 506 of FIG. 5.

In some examples, a display 902 of device 906 may display a user interface 904. The device 906 may be accessible to a user 908 (for example, a user such as regular user 142 as described with reference to FIG. 1). User 908 may view information displayed on user interface 904 and may interact with user interface 904 utilizing a keyboard, mouse touchpad, touchscreen, remote, voice command, or other interactive methods. In some examples, device 906 may be an example of device 144. User interface 904 may be an example of user interface 140.

In some examples, user interface 904 may include one or more content panels (for example, content panels 910, 914, 918, 920, 922) which display information and/or contain buttons/links that the user 908 may interact with.

In an example, content panel 910 may display information relating to jobs (i.e. tasks) that are active, and may include relevant textual information regarding the jobs (for example, status information). Content panel 910 may also include count displays of the number of active jobs which meet specified parameters (for example, 4 jobs are currently running a use case, 9 jobs are active but idle). Content panel 910 may also include one or more interactive buttons 912 for the user 908 to click on to be taken to another screen to initiate an action and/or direct user 908 to a different user interface (for example, a button 912 to create a new job).

In an example, content panel 914 may display information relating to one or more clusters that have been created and may include relevant textual information regarding the clusters (for example, status information). Content panel 914 may also include count displays of clusters or events which meet specified parameters. Content panel 914 may also include one or more interactive buttons 916 for the user 908 to click on to be taken to another screen to initiate an action and/or direct user 908 to a different user interface (for example, a button 916 to create a new job).

In some examples, more than one job/task (use cases) may run on a single cluster of resources. In some examples, a cluster may be divided into “slots” which may be utilized for particular jobs. In some examples, one cluster may be dedicated to one job/task (use case).

In an example, content panels 918, 920 may display information relating a particular job/task and may include relevant textual information regarding the jobs (for example, job type, number of one or more types of cores, processing type (batch or recurring, etc.), or other information). Content panels 918, 920 may also include count displays of the number of jobs, slots, clusters, or events which meet specified parameters (2 jobs are running and 2 slots are available). In some examples, content panels 918, 920 may also include one or more interactive buttons for the user 908 to click on to be taken to another screen to initiate an action and/or direct user 908 to a different user interface.

In some examples, a future content panel 922 may be displayed as a placeholder panel, which includes one or more interactive buttons for the user 908 to click on to be taken to another screen to initiate an action and/or direct user 908 to a different user interface (for example, a button to create a new task/job).

The dashboard user interface 904 may enable the user 908 to efficiently view monitored and measured information regarding clusters and jobs/tasks and may provide user 608 an efficient interface on which to initiate the creation of a new job.

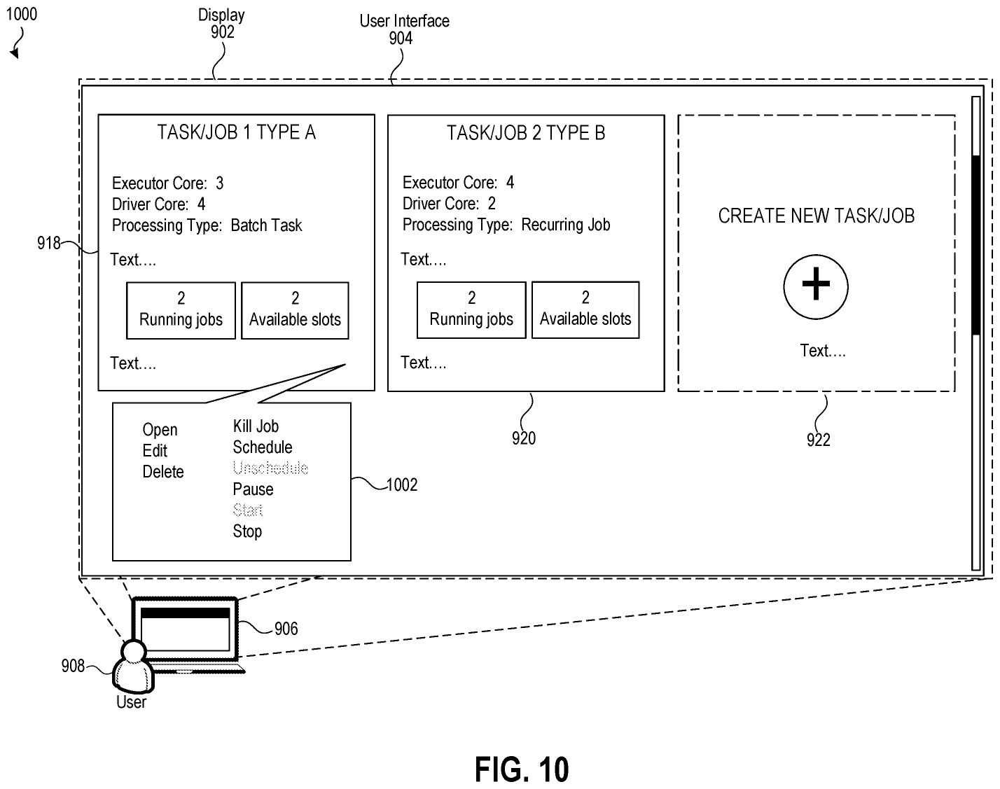

FIG. 10 illustrates further features of the user interface dashboard of FIG. 9, according to an example.

In an example, a user 908 may interact with one of content panels 918, 920 to open a menu 1002 of options relating to the job/task described in the panel. The menu 1002 may be opened, in some examples, by clicking a button or by right clicking a mouse button. The menu 1002 may include options such as open, edit, delete, kill job, schedule, unscheduled, pause, start, and/or stop. In some examples, options shown may be displayed as unavailable at the moment (for example, greyed out text) depending on the status of the job. For example, a job that is running may have an option to start the job shown as unavailable, because it is already running.

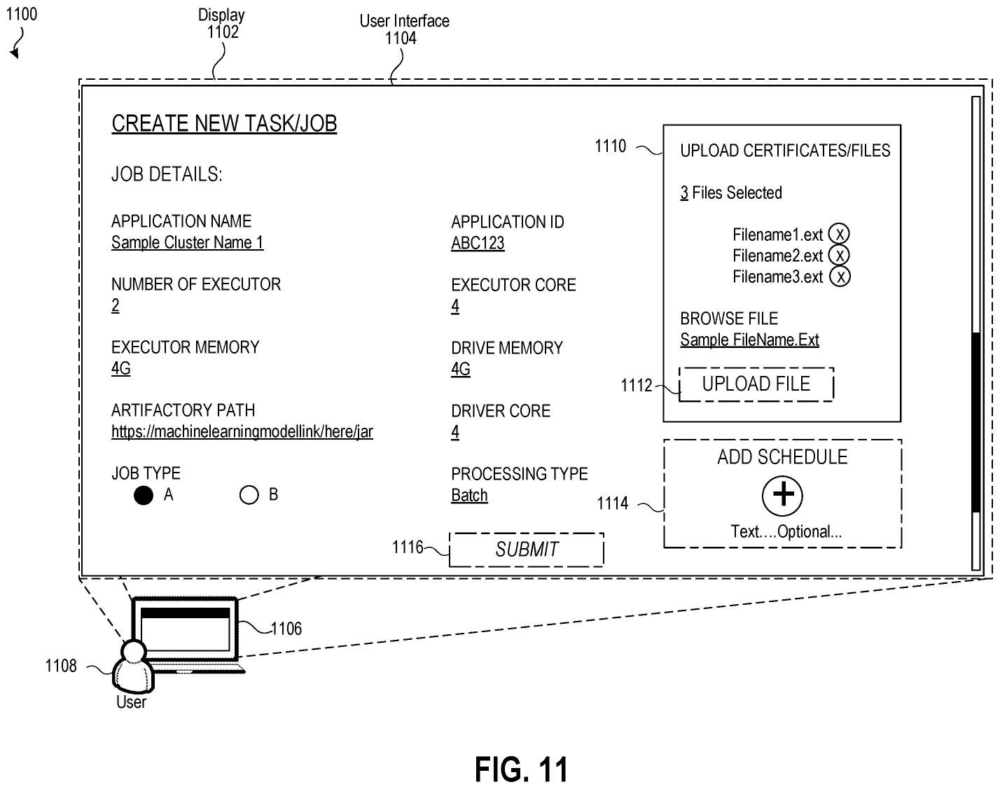

FIG. 11 illustrates a user interface 1104 for creating a job, according to an example.

In some examples, a display 1102 of device 1106 may display a user interface 1104. The device 1106 may be accessible to a user 1108 (for example, a user such as regular user 142 as described with reference to FIG. 1). User 1108 may view information displayed on user interface 604 and may interact with user interface 1104 utilizing a keyboard, mouse touchpad, touchscreen, remote, voice command, or other interactive methods. In some examples, device 1106 may be an example of device 144. User interface 1104 may be an example of user interface 140.

In some examples, user interface 1104 may include interactive data entry fields. Interactive data entry fields may be type-in fields, drop-down selection menus, radio buttons, checkboxes, sliders, uploads from links, or other appropriate means of data entry. These data entry fields may receive information from the user 1108 relating to a job and/or cluster to be formed. In some examples, data entry fields may include application name, number of one or more different types of cores, amount of different types of memory/computing resources required, a path to a script to be run, a job type (for example, Spark or Flink), a processing type (for example, batch or recurring), an application identifier (ID), and others. In the particular example shown, the data entry fields include an application name, number of executors, amount of executor memory, artifactory path, job type, application ID, executor cores, drive memory, driver cores, and processing type.

In some examples, user interface 1104 may include one or more content panels (for example, content panels 1110, 1114) which display information and/or contain buttons/links that the user 608 may interact with. In an example, content panel 1110 includes a data entry field where a link/path to one or more certificates or files may be entered so that the certificates or files may be uploaded to the job. Certificates or files may be related to data to be stored, models to be run, security features necessary, or other features or purposes. Content panel 1110 may include a button 1112 where a user 1108 may interact/click to initiate upload of the file. After certificates or files are uploaded, content panel 1110 may display the filenames of the uploaded files, in some examples as a list. In some examples, content panel 1110 may include a means (for example, small buttons next to each filename) by which the user 1108 may remove an uploaded file.

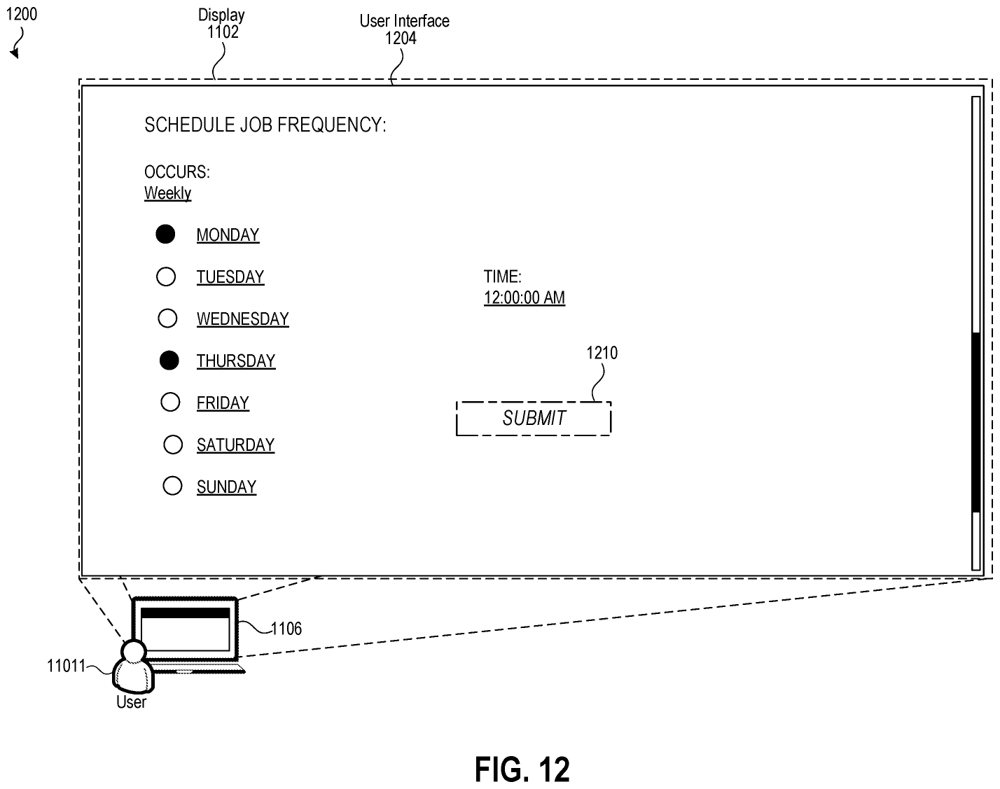

In an example, (future) control panel 1114 may include a button or other interactive means whereby the user may initiate the addition of a schedule to the creation of the job or task. In some examples, clicking or otherwise selecting control panel 1114 may direct the user 1108 to another user interface, such as that shown in FIG. 12.

In an example, user interface 1104 may include a submit button 1116, which the user 1108 may interact with (for example, click or select) to initiate creation of the job and/or associated cluster.

In some examples, user interface 1104 may include a graphical user interface (GUI), as shown in FIG. 11. In an alternative example, user interface 1104 may include a CLI by which a user may instantiate a cluster of computing resources in situations where issuance of commands is preferred to a GUI (for example, in a terminal or shell environment utilized by a developer). Such commands entered into the CLI may include at least some of the same options that are displayed to the user via the GUI as shown in FIGS. 11, 12, and 14.

FIG. 12 illustrates a user interface 1204 for scheduling a job, according to an example. User interface 1204 may be an example of user interface 140.

In some examples, user interface 1204 may include interactive data entry fields. Interactive data entry fields may be type-in fields, drop-down selection menus, radio buttons, checkboxes, sliders, uploads from links, or other appropriate means of data entry. These data entry fields may receive information from the user 1108 relating to a scheduling a job, where the job is to be performed once at a particular time, or when the job is to be recurring at a plurality of particular times. In some examples, data entry fields may include selection of a frequency of recurrence (for example, one time, weekly, bi-weekly, monthly, bi-monthly, every other week, quarterly, yearly, etc.); days of the week; and time of day. For example, in the particular example shown the job is scheduled to run weekly every Monday and Thursday at 12:00:00 AM.

In an example, user interface 1204 may include a submit button 1210, which the user 1108 may interact with (for example, click or select) to initiate scheduling of the job.

Scheduling of the job may in some examples, complete the job creation process (for example, clicking of submit button 1210) and creation of the job and associated cluster may begin. In some examples, scheduling of the job (for example, clicking of submit button 1210) may return the user 1108 back to the job creation user interface 1104. In that example, control panel 1114 may show as an active control panel (no longer as a future control panel) and may display details of the schedule. User 1108 may then select submit button 1116 to begin the creation of the job and associated cluster, which will run a use case according to the schedule.

Scheduling the job allows the user 1108 to schedule/set up a job which only needs to run once to run at a specific time, where that time is important to the use case but may be inconvenient or difficult for the user 1108 to start the job manually at that time. Scheduling the job allows the user 1108 to ensure that a job which needs to recur is set up with a cluster of resources each time the job needs to run, without the user 1108 needing to recreate the job and/or cluster each time the job needs to be run. In some examples, in between the runs of a recurring scheduled job, the computing resources allocated to the cluster associated with the job may be de-allocated from the cluster and are released to the provider hosting the cluster. This allows for those computing resources to be used for other jobs/clusters during that time. In some examples, the computing resources allocated to the cluster associated with the job remain allocated to the cluster associated with the job in between the runs of a recurring scheduled job, ensuring that they are held available for the needs of the cluster at all times and will not be double-allocated when it is time to run the use case.

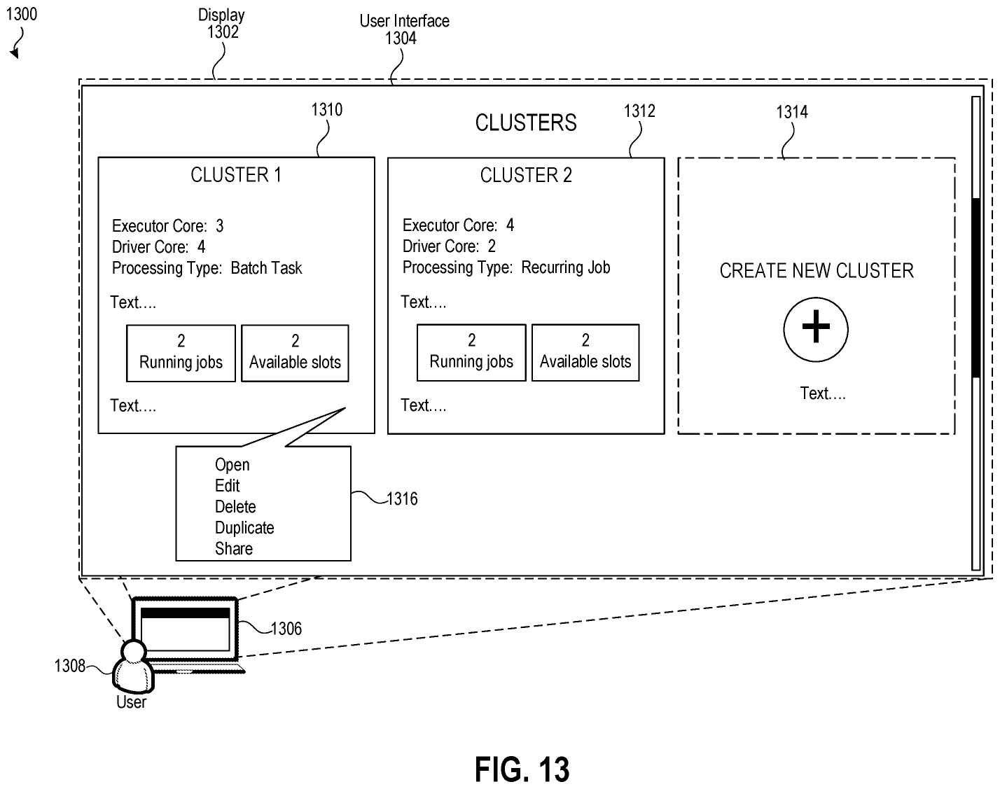

FIG. 13 illustrates a user interface dashboard for monitoring and creating clusters, according to an example.

In some examples, a display 1302 of device 1306 may display a user interface 1304. The device 1306 may be accessible to a user 1308 (for example, a user such as SDK user 148 as described with reference to FIG. 1). User 1308 may view information displayed on user interface 1304 and may interact with user interface 1304 utilizing a keyboard, mouse touchpad, touchscreen, remote, voice command, or other interactive methods. In some examples, device 1306 may be an example of device 150. User interface 1304 may be an example of user interface 146.

In some examples, user interface 1304 may include one or more content panels (for example, content panels 1310, 1312, 1314) which display information and/or contain buttons/links that the user 1308 may interact with.

In an example, content panels 1310, 1312 may display information relating a particular cluster, and may include relevant textual information regarding the cluster (for example, cluster name or designation, number of one or more types of cores, processing type (batch or recurring, etc.), or other information). Content panels 1310, 1312 may also include count displays of the number of jobs, slots, or events which meet specified parameters (for example, 2 jobs are running and 2 slots are available). In some examples, content panels 1310, 1312 may also include one or more interactive buttons for the user 1308 to click on to be taken to another screen to initiate an action and/or direct user 1308 to a different user interface.

In some examples, more than one job/task (use cases) may run on a single cluster of resources. In some examples, a cluster may be divided into “slots” which may be utilized for particular jobs. In some examples, one cluster may be dedicated to one job/task (use case).

In some examples, a future content panel 1314 may be displayed as a placeholder panel, which includes one or more interactive buttons for the user 1308 to click on to be taken to another screen to initiate an action and/or direct user 1308 to a different user interface (for example, a button to create a new cluster).

The dashboard user interface 1304 may enable the user 1308 to efficiently view monitored and measured information regarding clusters and jobs and may provide user 1308 an efficient interface on which to initiate the creation of a new cluster.

In an example, a user 1308 may interact with one of content panels 1310, 1312 to open a menu 1316 of options relating to the cluster described in the panel. The menu 1316 may be opened, in some examples, by clicking a button or by right clicking a mouse button. The menu 1316 may include options such as open, edit, delete, duplicate, and share. In some examples, options shown may be displayed as unavailable at the moment (for example, greyed out text) depending on the status of the cluster.

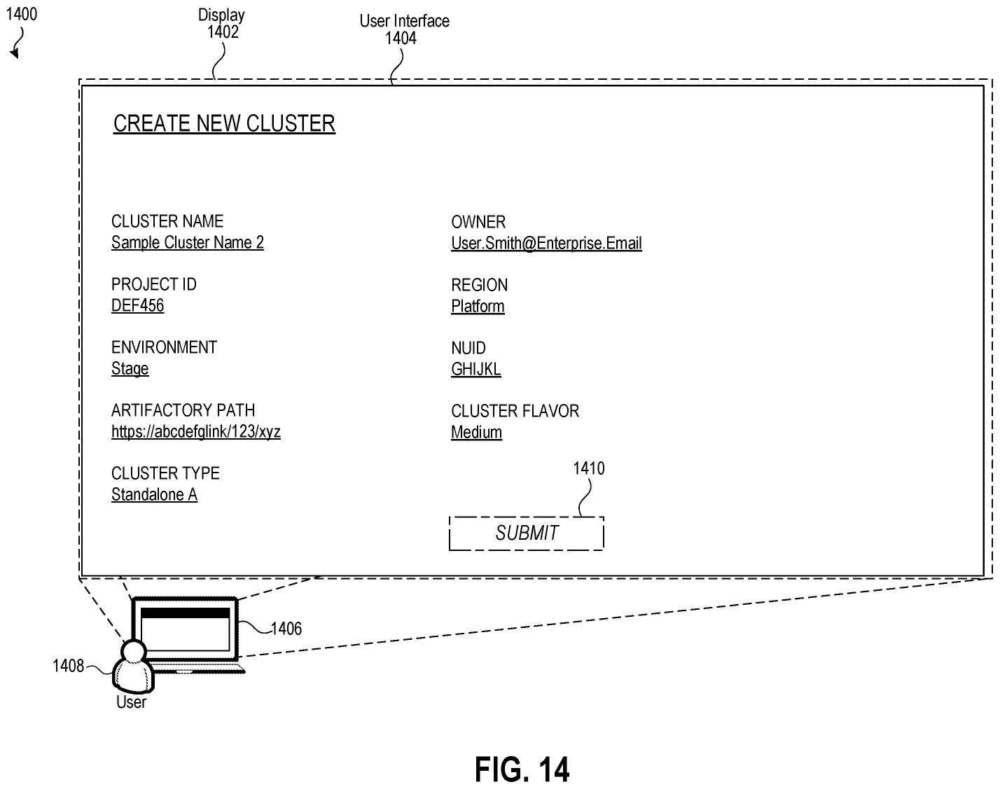

FIG. 14 illustrates a user interface for creating a cluster, according to an example.

In some examples, a display 1402 of device 1406 may display a user interface 1404. The device 1406 may be accessible to a user 1408 (for example, a user such as SDK user 148 as described with reference to FIG. 1). User 1408 may view information displayed on user interface 1404 and may interact with user interface 1404 utilizing a keyboard, mouse touchpad, touchscreen, remote, voice command, or other interactive methods. In some examples, device 1406 may be an example of device 150. User interface 1404 may be an example of user interface 146.

In some examples, user interface 1404 may include interactive data entry fields. Interactive data entry fields may be type-in fields, drop-down selection menus, radio buttons, checkboxes, sliders, uploads from links, or other appropriate means of data entry. These data entry fields may receive information from the user 1408 relating to a job and/or cluster to be formed. In some examples, data entry fields may include cluster name, owner name or email address, amount of different types of memory/computing resources required, a path to a script to be run, a cluster type, a project identifier (ID), an environment in which to create the cluster, a region in which to create the cluster, a unique user device identifier, a cluster flavor (i.e. a predetermined allocation category of the cluster, which may be a predetermined size or layout of cluster including a predetermined amount of each of one or more computing resources, and having a designation such as small, medium, large, etc.), and other fields. In the particular example shown, the data entry fields include a cluster name, an owner email address, a blossom ID, an environment, a region, a unique user device identifier, an artifactory path, a cluster type, and a cluster flavor.

In an example, user interface 1404 may include a submit button 1410, which the user 1408 may interact with (for example, click or select) to initiate creation of the cluster.

In some examples, the computing resources allocated to a cluster created via user interface 1404 may remain allocated to the user 1408 until the user 1408 chooses to edit or delete the cluster. This provides the user 1408 the ability to have the allocated resources available for use at any time he or she desires to utilize them, without having to re-create the cluster.

In some examples, some or all of the computing resources allocated to a cluster created via user interface 1404 may be released to the resource provider (and de-allocated from the cluster) if the cluster is found (by monitoring and/or measurement) to have not run a job (use case) in a predetermined period of time. This enables the resource provider to have as many computing resources as possible available for allocation to other clusters or for other uses.

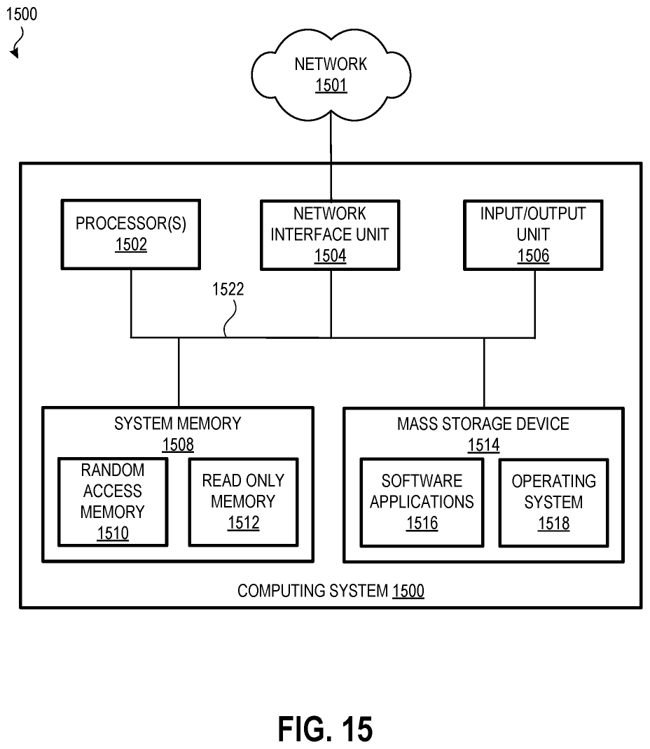

FIG. 15 illustrates an example block diagram of a virtual or physical computing system 1500. One or more aspects of the computing system 1500 can be used to implement the cluster management system 102, store instructions described herein, and preform operations described herein.

In the embodiment shown, the computing system 1500 includes one or more processors 1502, a system memory 1508, and a system bus 1522 that couples the system memory 1508 to the one or more processors 1502. The system memory 1508 includes RAM (Random Access Memory) 1510 and ROM (Read-Only Memory) 1512. A basic input/output system that contains the basic routines that help to transfer information between elements within the computing system 1500, such as during startup, is stored in the ROM 1512. The computing system 1500 further includes a mass storage device 1514. The mass storage device 1514 is able to store software instructions and data. The one or more processors 1502 can be one or more central processing units or other processors.

The mass storage device 1514 is connected to the one or more processors 1502 through a mass storage controller (not shown) connected to the system bus 1522. The mass storage device 1514 and its associated computer-readable data storage media provide non-volatile, non-transitory storage for the computing system 1500. Although the description of computer-readable data storage media contained herein refers to a mass storage device, such as a hard disk or solid-state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, DVD (Digital Versatile Discs), other optical storage media, magnetic cassettes, magnetic tape, magnetic disk storage or other magnetic storage devices, or any other medium which can be used to store the desired information and which can be accessed by the computing system 1500.

According to various embodiments of the invention, the computing system 1500 may operate in a networked environment using logical connections to remote network devices through the network 1501. The network 1501 is a computer network, such as an enterprise intranet and/or the Internet. The network 1501 can include a LAN, a Wide Area Network (WAN), the Internet, wireless transmission mediums, wired transmission mediums, other networks, and combinations thereof. The computing system 1500 may connect to the network 1501 through a network interface unit 1504 connected to the system bus 1522. It should be appreciated that the network interface unit 1504 may also be utilized to connect to other types of networks and remote computing systems. The computing system 1500 also includes an input/output controller 1506 for receiving and processing input from a number of other devices, including a touch user interface display screen, or another type of input device. Similarly, the input/output controller 1506 may provide output to a touch user interface display screen or other type of output device.

As mentioned briefly above, the mass storage device 1514 and the RAM 1510 of the computing system 1500 can store software instructions and data. The software instructions include an operating system 1518 suitable for controlling the operation of the computing system 1500. The mass storage device 1514 and/or the RAM 1510 also store software instructions, that when executed by the one or more processors 1502, cause one or more of the systems, devices, or components described herein to provide functionality described herein. For example, the mass storage device 1514 and/or the RAM 1510 can store software instructions that, when executed by the one or more processors 1502, cause the computing system 1500 to receive and execute managing network access control and build system processes.

While particular uses of the technology have been illustrated and discussed above, the disclosed technology can be used with a variety of data structures and processes in accordance with many examples of the technology. The above discussion is not meant to suggest that the disclosed technology is only suitable for implementation with the data structures shown and described above. For example, while certain technologies described herein were primarily described in the context of defining and managing clusters of computing resources, technologies disclosed herein are applicable to data structures generally.

This disclosure described some aspects of the present technology with reference to the accompanying drawings, in which only some of the possible aspects were shown. Other aspects can, however, be embodied in many different forms and should not be construed as limited to the aspects set forth herein. Rather, these aspects were provided so that this disclosure was thorough and complete and fully conveyed the scope of the possible aspects to those skilled in the art.

As should be appreciated, the various aspects (e.g., operations, memory arrangements, etc.) described with respect to the figures herein are not intended to limit the technology to the particular aspects described. Accordingly, additional configurations can be used to practice the technology herein and/or some aspects described can be excluded without departing from the methods and systems disclosed herein.

Similarly, where operations of a process are disclosed, those operations are described for purposes of illustrating the present technology and are not intended to limit the disclosure to a particular sequence of operations. For example, the operations can be performed in differing order, two or more operations can be performed concurrently, additional operations can be performed, and disclosed operations can be excluded without departing from the present disclosure. Further, each operation can be accomplished via one or more sub-operations. The disclosed processes can be repeated.

Although specific aspects were described herein, the scope of the technology is not limited to those specific aspects. One skilled in the art will recognize other aspects or improvements that are within the scope of the present technology. Therefore, the specific structure, acts, or media are disclosed only as illustrative aspects. The scope of the technology is defined by the following claims and any equivalents therein.

1. A computing system, comprising:
at least one processor; and
at least one memory storing computer-executable instructions for defining a cluster of computing resources, the computer-executable instructions when executed by the at least one processor causing the computer to:
receive input data from a user interface accessible from a user computing device, the input data being associated with creating a cluster, wherein the input data comprises one or more of:
a use case associated with the cluster;
a run start time;
a cluster data type;
an amount of computing resources, including at least one of an amount of processing resources and an amount of memory;
an environment in which to create the cluster; and
a predetermined allocation category of the cluster;
prepare a cluster request associated with the input data;
receive an image of an execution environment adapted for use according to the cluster request;
determine, based on the input data, whether to create the cluster using enterprise computing resource infrastructure or to create the cluster using a third party computing resource infrastructure;
establish a connection with a provider of a chosen computing resource infrastructure, the chosen computing resource infrastructure being selected from among the enterprise computing resource infrastructure and the third party computing resource infrastructure;
utilizing the image of the execution environment, create clusters with the chosen computing resource provider, wherein creating clusters comprises:
assigning an amount of computing resources equal to or greater than the amount of computing resources defined within the input data;
scheduling the cluster to run the use case at the run start time; and
preparing IP addresses of nodes of the chosen computing resource provider grouped into clusters; and
utilize the cluster to run the use case, wherein running the use case includes calling a script.

2. The computing system of claim 1, further comprising instructions to:
monitor a performance of the cluster when the cluster is running the use case.

3. The computing system of claim 2, further comprising instructions to:
determine, based on the monitored performance of the cluster, that a measured actual amount of memory being utilized to run the use case is lower than an amount of the computing resources defined in the input data; and
in response to determining that the actual amount of computing resources utilized is lower than the amount of computing resources defined in the input data, automatically deallocate a portion of the memory assigned to the cluster.

4. The computing system of claim 2, further comprising instructions to:
determine, based on the monitored performance of the cluster, that the amount of computing resources defined in the input data is insufficient to run the use case; and
in response to determining that the computing resources defined in the input data is insufficient for adequate performance according to the use case, automatically increase the amount of computing resources allocated to the cluster.

5. The computing system of claim 2, further comprising instructions to:
output performance metrics associated with the monitored performance of the cluster to a dashboard user interface.

6. The computing system of claim 5, further comprising instructions to:
change the amount of computing resources assigned to the cluster, based on edit inputs received from a user via the dashboard user interface.

7. The computing system of claim 1, further comprising instructions to:
determine that the use case has been run to a completion point; and
upon reaching the completion point, automatically decommission the cluster to release the amount of computing resources to the chosen provider.

8. The computing system of claim 1, further comprising instructions to:
based on the use case indicating that the use case is a reoccurring job, schedule the cluster to automatically run the use case at a second run start time.

9. The computing system of claim 8, further comprising instructions to:
after running the use case, determine that the use case has been run to a completion point;
temporarily deallocate the computing resources assigned to the cluster;
release the computing resources to the chosen provider until the second run start time;
create a second instance of the cluster according to the input data;
reassign the computing resources to the second instance of the cluster; and
utilize the second instance of the cluster to automatically run the use case at the second run start time.

10. The computing system of claim 1, wherein the script is called from a database location, wherein the input data includes a database location path.

11. The computing system of claim 1, wherein the script is called from a location on a user device, wherein the input data includes a user device path.

12. The computing system of claim 1, wherein running the use case includes performing a data enrichment job.

13. A computing system, comprising:
at least one processor; and
at least one memory storing computer-executable instructions for defining a cluster of computing resources as a service, the computer-executable instructions when executed by the at least one processor causing the computer to:
receive input data from a user, via a software development kit, the input data being associated with creating a cluster, wherein the input data comprises one or more of:
a platform designation;
a use case associated with the cluster;
an owner designation;
a cluster data type;
an environment in which to create the cluster; and
a predetermined allocation category;
prepare a cluster request associated with the input data;
receive an image of an execution environment adapted for use according to the cluster request;
determine, based on the platform designation, whether to create the cluster using an enterprise computing resource infrastructure or to create the cluster using a third party computing resource infrastructure
establish a connection with a provider of a chosen computing resource infrastructure, the chosen computing resource infrastructure being selected from among the enterprise computing resource infrastructure and the third party computing resource infrastructure;
utilizing the image, create clusters with the chosen computing resource provider, wherein creating clusters comprises:
assigning an amount of computing resources consistent with the predetermined allocation category;
scheduling the cluster to run the use case at a run start time; and
preparing IP addresses of nodes of the computing resource provider grouped into clusters;
utilize the cluster to run the use case, wherein running the use case includes calling a script;
determine that the cluster has not been utilized to run a second use case for a predetermined period of time; and
automatically decommission the cluster to release the amount of computing resources to the chosen provider.

14. The computing system of claim 13, further comprising instructions to:
monitor a performance of the cluster when the cluster is running the use case.

15. The computing system of claim 14, further comprising instructions to:
output performance metrics associated with the monitored performance of the cluster to a dashboard user interface.

16. The computing system of claim 15, further comprising instructions to:
change the amount of computing resources assigned to the cluster, based on edit inputs received from a user via the dashboard user interface.

17. The computing system of claim 13, further comprising instructions to:
monitor a status of the cluster when the cluster is not running the use case.

18. A method, comprising:
receiving a request to create a cluster from a user interface, wherein the request includes input data, the input data comprising one or more of:
a use case associated with the cluster;
a run start time;
a cluster data type;
an amount of computing resources required;
an environment in which to create the cluster; and
a predetermined allocation category of the cluster;
storing the request;
receiving an image of an execution environment adapted for use according to the request;
selecting a resource provider from among a plurality of different resource providers on which to create the cluster;
establishing a connection with an application programming interface associated with the selected resource provider;
generating a set of commands, the set of commands comprising:
a creation command to create a cluster based on the image, wherein creating a cluster comprises:
assigning an amount of computing resources equal to or greater than the amount of computing resources required;
scheduling the cluster to run the use case at the run start time; and
preparing IP addresses of nodes of the selected resource provider grouped into clusters;
a status command to receive a cluster status; and
a detail command to receive one or more details of the cluster;
issuing the set of commands to the application programming interface associated with the selected resource provider;
in response to the application programming interface executing the set of commands, utilizing the cluster to run the use case, wherein running the use case includes calling a script.

19. The method of claim 18, further comprising:
monitoring a performance of the cluster when the cluster is running the use case.

20. The method of claim 19, wherein monitoring the performance of the cluster comprises:
sending an instruction to the application programming interface to measure cluster performance;
receiving cluster performance information from the application programming interface; and
outputting performance metrics associated with the cluster performance information to a dashboard user interface.
